(19) United States
(12) Patent Application Publication
(10) Pub. No.: US 2019/0320502 A1
(43) Pub. Date: Oct. 17, 2019

(54) Heating Cable Routing for Anti-Icing Cassettes

(71) Applicant: nVent Services GmbH, Schaffhausen (CH)

(72) Inventor: Wesley Dong, Belmont, CA (US)

(21) Appl. No.: 16/386,130

(22) Filed: Apr. 16, 2019

Related U.S. Application Data
(60) Provisional application No. 62/658,365, filed on Apr. 16, 2018.

(51) Int. Cl. H05B 3/56; B63B 35/08; B63B 35/44

(52) U.S. Cl. CPC H05B 3/56; B63B 35/08; H05B 2214/02; H05B 2203/026; B63B 35/44

(57) ABSTRACT

A system and method of heating cable routing for anti-icing cassettes is provided. An anti-icing cassette includes a panel, a plurality of channel segments arranged on an underside of the panel, and a heating cable routed through the plurality of channel segments and arranged in a concentric manner, including an outer loop and at least one concentric inner loop inside the outer loop.

### CROSS-REFERENCE TO RELATED APPLICATION

This application is a non-provisional claiming the benefit of U.S. Prov. Pat. App. Ser. No. 62/658,365, filed under the same title on Apr. 16, 2018, and incorporated fully herein by reference.

### BACKGROUND OF THE INVENTION

Ships and offshore platforms used in cold-weather environments often include “anti-icing” panels, also known as cassettes, for preventing ice formation along walking paths and escape ways. The panels are typically made of a metal (such as aluminum) or rubber substrate and electrical heating cables. For example, the panels are fastened to the decks of ships and platforms so that the panel surfaces form walking paths, and heat generated by the cables helps reduce ice formation on the panel surfaces. The electrical heating cables are embedded in or coupled to an underside of the panel and are typically arranged in a serpentine nature. More specifically, a typical cassette includes a heating cable routed back and forth, forming parallel lines with looped ends traversing across the panel.

### SUMMARY OF THE INVENTION

In some embodiments of the present disclosure, an anti-icing cassette is provided that includes a panel and a plurality of channel segments arranged on an underside of the panel. A heating cable is routed through the plurality of channel segments and is arranged in a concentric manner, including an outer loop adjacent an outer perimeter of the panel and at least one concentric inner loop inside the outer loop. Embodiments of the anti-icing cassette can include any one or a combination of the following features provided herein.

In some embodiments, the heating cable can terminate inside the outer loop. Moreover, in some embodiments, the heating cable can be bent at a substantially 90-degree angle to be routed from a first channel segment of the plurality of channel segments to an adjacent second channel segment of the plurality of channel segments.

In some embodiments, the plurality of channel segments can include a first channel segment, a second channel segment, a third channel segment, and a fourth channel segment arranged relative to each other to form the outer loop. The plurality of channel segments can include extruded metal slots defined by a base structure and a pair of projections extending from the base structure. The plurality of channel segments can each include at least one flange positioned laterally outward of the pair of projections. The first channel segment can be substantially parallel to a first section of a perimeter of the panel, the second channel segment can be substantially parallel to a second section of the perimeter of the panel, the third channel segment can be substantially parallel to a third section of the perimeter of the panel, and a fourth channel segment can be substantially parallel to a third section of the perimeter of the panel.

In some embodiments, one or more supports can extend further from the panel than the plurality of channel segments arranged on an underside of the panel. Additionally or alternatively, a transition member operably coupled with the panel, the transition member having a chamfered outer surface and a vertical inner surface.

In some embodiments of the present disclosure, an anti-icing cassette is provided that includes a panel and a plurality of channel segments arranged on an underside of the panel. The plurality of channel segments include a first channel segment parallel to a first section of a perimeter of the panel and a second channel segment parallel to a second section of the perimeter. A first heating cable is routed through the plurality of channel segments and is arranged in a concentric manner. The first heating cable defines a bend portion between the first and second channel segment. Embodiments of the anti-icing cassette can include any one or a combination of the following features provided herein.

In some embodiments, the first channel segment can be arranged about 90 degrees relative to the second channel segment. The first heating cable can be biased towards the vertical members and away from the transition members.

In some embodiments, the panel can include a panel and a pair of side members extending downwardly from the panel, the side members disposed on adjacent sides of the panel and separated from one another. Additionally or alternatively, a pair of transition members can be operably coupled with two adjacent sides of the panel, the transition members including a chamfered outer surface.

In some embodiments, a second heating cable, wherein the first and second cables are disposed in respective first and second slots within at least one of the plurality of channel segments.

In some embodiments of the present disclosure, a method of routing a heating cable on an underside of an anti-icing cassette is provided. The method includes routing the heating cable through a first plurality of channel segments coupled to the underside of the anti-icing cassette to form an outer loop adjacent to a perimeter the anti-icing cassette. The method also includes routing the heating cable through a second plurality of channel segments coupled to the underside of the anti-icing cassette to form an inner concentric loop inside the outer loop. In addition, the method includes terminating the heating cable at a location inside the outer loop. Embodiments of the method of routing a heating cable on an underside of an anti-icing cassette can include any one or a combination of the following features provided herein.

In some embodiments, the routing the heating cable through a first plurality of channel segments and the routing the heating cable through a second plurality of channel segments can bias the cable in an offset position from a center point of the cassette. The routing the heating cable through a first plurality of channel segments step can include positioning the heating cable within first and second channel segments within the first plurality of channel segments, the first and second channel segments offset from one another by less than 180 degrees. The routing the heating cable through a second plurality of channel segments step can include biasing the inner concentric loop towards a perimeter section of a panel of the anti-icing cassette.

In some embodiments, the method can further include attaching a support to a panel of the anti-icing cassette between the outer loop and the inner loop.

These and other aspects of the invention will become apparent from the following description. In the description, reference is made to the accompanying drawings which form a part hereof, and in which there is shown embodiments of the invention. Such embodiments do not necessarily represent the full scope of the invention and reference is made, therefore, to the claims herein for interpreting the scope of the invention.

### BRIEF DESCRIPTION OF THE DRAWINGS

The present invention will hereafter be described with reference to the accompanying drawings, wherein like reference numerals denote like elements.

FIG. 1 is an underside view of an anti-icing cassette including a serpentine cable-routing configuration.

FIG. 2 is a schematic view of a concentric cable routing configuration utilizing a single cable, according to some embodiments.

FIG. 3 is a schematic view of a concentric cable routing configuration utilizing more than one cable, according to some embodiments.

FIG. 4 is a top plan view of an anti-icing cassette, according to some embodiments.

FIG. 5 is a top perspective view of the anti-icing cassette, according to some embodiments.

FIG. 6 is a side plan view of the anti-icing cassette, according to some embodiments.

FIG. 7 is a bottom plan view of the anti-icing cassette, according to some embodiments, including a concentric cable-routing configuration.

FIG. 8 is a cross-sectional view of the anti-icing cassette taken along the line VIII-VIII of FIG. 4.

FIG. 9 is a bottom perspective view of a channel segment of the anti-icing cassette having a single slot.

FIG. 10 is a bottom perspective view of a channel segment of the anti-icing cassette having a pair of segregated slots.

### DETAILED DESCRIPTION OF PREFERRED EMBODIMENTS

Before the present invention is described in further detail, it is to be understood that the invention is not limited to the particular aspects described. It is also to be understood that the terminology used herein is for the purpose of describing particular aspects only, and is not intended to be limiting. The scope of the present invention will be limited only by the claims. As used herein, the singular forms “a”, “an”, and “the” include plural aspects unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising”, “including”, or “having” should be interpreted as referring to elements, components, or steps in a non-exclusive manner, so the referenced elements, components, or steps may be combined with other elements, components, or steps that are not expressly referenced. Aspects referenced as “comprising”, “including”, or “having” certain elements are also contemplated as “consisting essentially of” and “consisting of” those elements, unless the context clearly dictates otherwise. It should be appreciated that aspects of the invention that are described with respect to a system are applicable to the methods, and vice versa, unless the context explicitly dictates otherwise.

Numeric ranges disclosed herein are inclusive of their endpoints. For example, a numeric range of between 1 and 10 includes the values 1 and 10. When a series of numeric ranges are disclosed for a given value, the present disclosure expressly contemplates ranges including all combinations of the upper and lower bounds of those ranges. For example, a numeric range of between 1 and 10 or between 2 and 9 is intended to include the numeric ranges of between 1 and 9 and between 2 and 10.

Embodiments of the present invention are generally directed toward anti-icing cassettes. According to some embodiments, rather than routing cables back and forth in a serpentine configuration, one or more heating cables may be routed in concentric loops. This concentric routing of the heating cables may provide multiple benefits over serpentine routing such as, but not limited to, more efficient heating of the cassette, more uniform heating profile across the cassette by providing additional heat proximate heat sinks, and better thermal coupling of the heating cable to the surface to be heated. In addition, the cassette provided herein can utilize less electrical power usage during operation than conventional cassettes, which can lead to energy savings and less component degradation over time. Some embodiments of the invention may be used in certain environments, such as ship or oil platform environments. These environments encounter extreme temperatures that quickly become hazardous when surfaces, such as decks, walkways, and stairs, are not adequately maintained free of ice and snow. Additionally, some embodiments may be used in other environments, such as roadways, driveways, sidewalks, roofs, gutters, and so on.

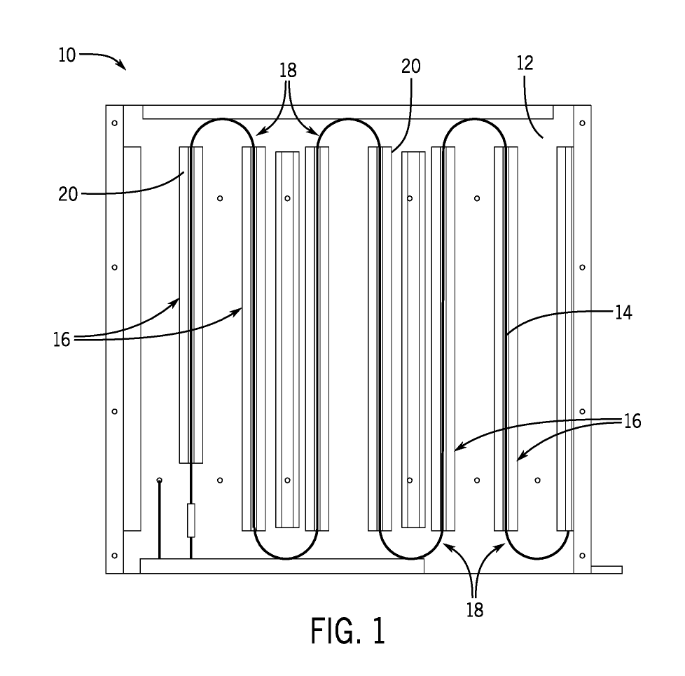

For example, FIG. 1 illustrates a cassette 10 having a serpentine cable configuration. The cassette 10 includes a panel 12 and a heating cable 14 routed back and forth across an underside of the panel 12, forming parallel lines 16 with looped ends 18. Also, conduits 20 can be used to arrange the heating cable 14 in this layout and to thermally couple the heating cable 14 to the panel 12. As shown in FIG. 1, the extruded conduits 20 are typically installed on or integrated with the underside of the panel 12 to receive straight sections of the heating cable 14 (e.g., along the parallel lines 16).

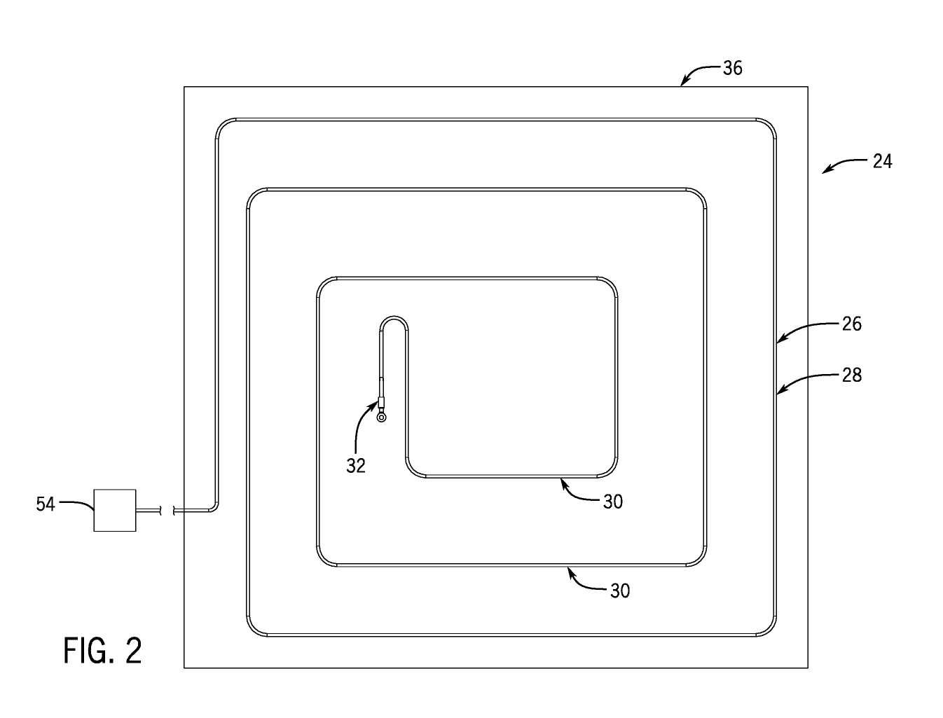

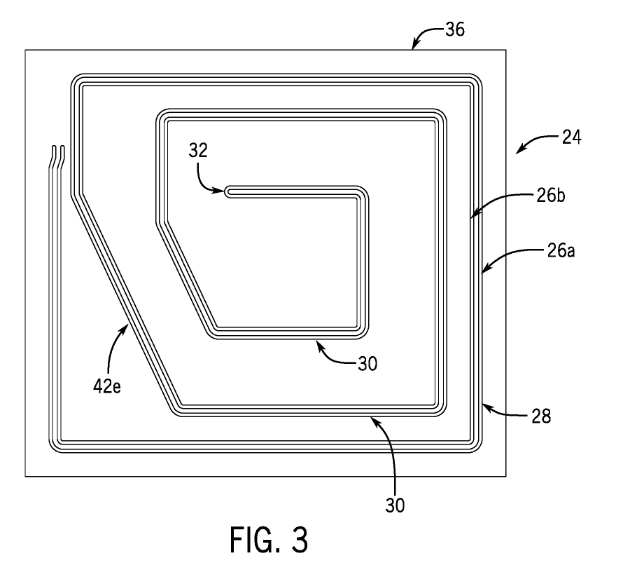

FIGS. 2 and 3 illustrate various concentric routing patterns 24 according to some embodiments. Unlike the serpentine configuration of FIG. 1, the patterns 24 include at least one cable 26 routed in a first outer loop 28 and one or more concentric inner loops 30 inside the outer loop 28 until reaching a termination point 32 inside the outer loop 28. The loops 28, 30 may be considered concentric because they generally share a center and the inner loop 30 can be substantially completely surrounded by the outer loop 28. In some embodiments, the heating cable 26 can be terminated using a terminator or termination kit. Herein, a “loop” may be a substantially square, rectangular, or polygonal loop. Furthermore, in some embodiments, a “loop” may be a substantially circular or oblong loop. Also, in some embodiments, the concentric pattern may be considered a spiral pattern.

As illustrated in FIG. 3, in some embodiments, first and second cables 26a, 26b are powered in series. The heating cables 26a, 26b can be coupled to one or more controllers 54 that manage power application to the cables 26a, 26b (e.g., by applying an electrical current to the cable conductors, causing heat generation along the cable length). In some instances, the power application to the cables 26a, 26b may additionally or alternatively be provided through a cassette 36 that is proximate to the cassette 36, such that multiple cassettes 36 may be electrically connected in series, or in parallel, where an alternating current (AC) signal applied at the cable of a first cassette 36 in the series will cause current to flow through the heat tracing cables of each of the cassettes in the series, thereby heating each of the cassettes 36 in the series. Any number of cables 26a, 26b may be used in the routing pattern 24 depending on the desired amount of heat transfer, cable properties such as heater type (e.g., self-regulating, constant wattage, hazardous environment rated, etc.), diameter and bend radius of the cable, type of power attachment, and size and material of the cassette 36, etc. In embodiments having a single cable 26, the cable 26 may be similarly powered by any method provided herein.

In embodiments having more than one cable 26 powered in series, the pair of cables 26a, 26b may be a single cable that is folded at the termination point 32. Accordingly, the termination point 32 may be free of joints, and thus may not need a terminator or an end seal kit. Herein, a “joint” may be an end of a cable or wire. By forming a system that is free of joints at the termination point 32, the cassette 36 may be less expensive to manufacture due to the need for fewer components. Likewise, due to the need for fewer components, the cassette 36 may be more robust than conventional cassettes. The removal of the joint may also create a more efficient heating system.

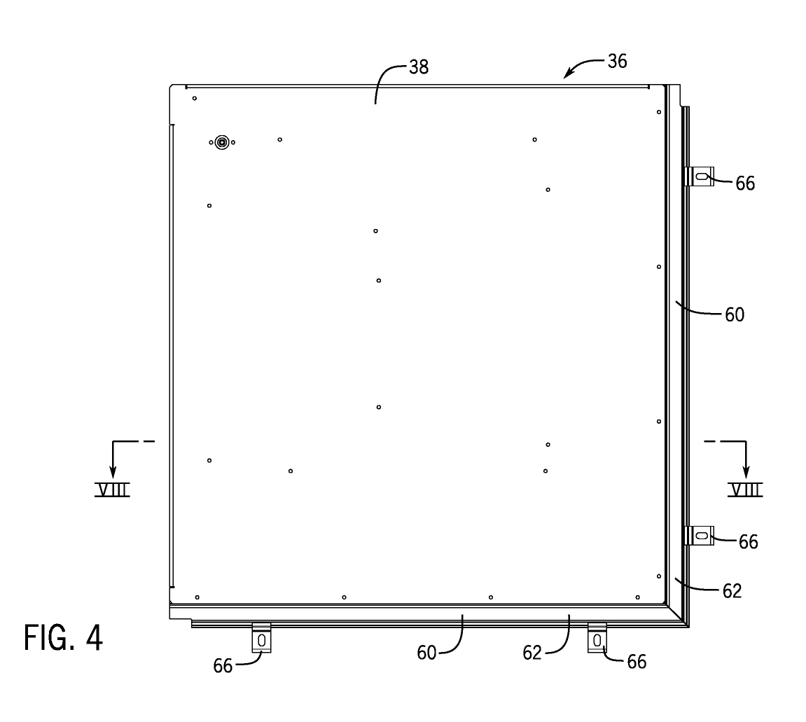

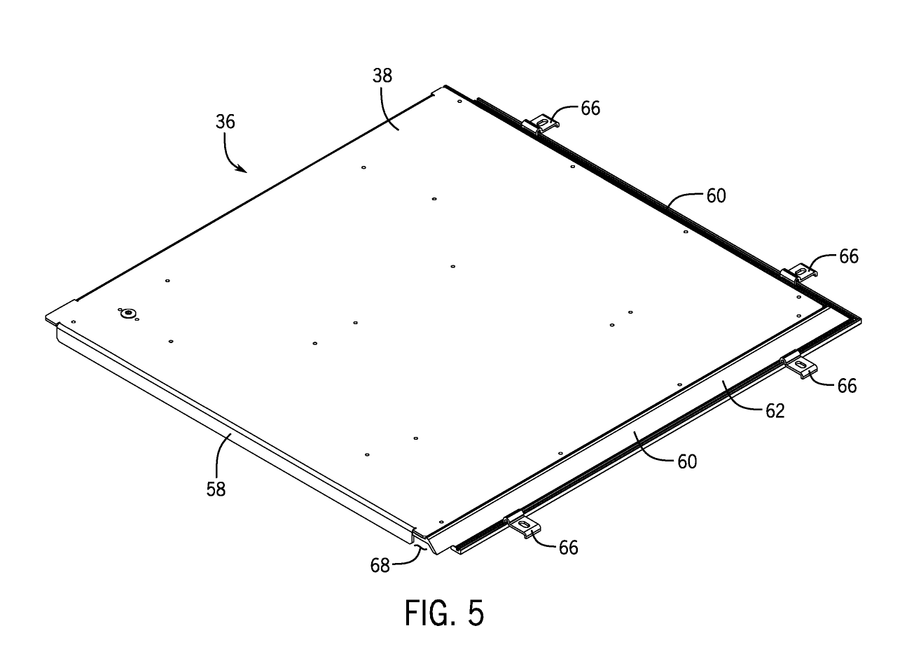

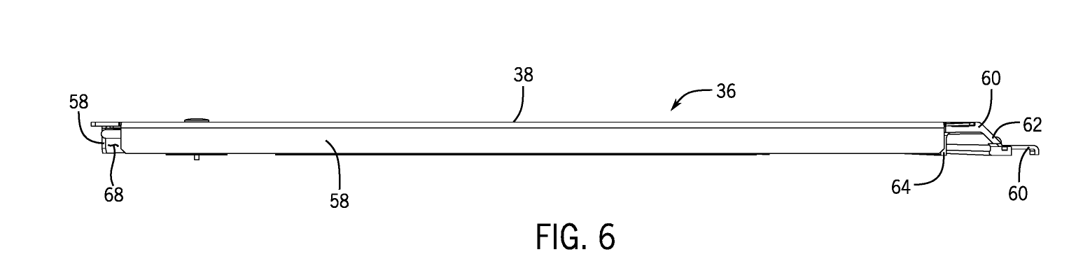

As illustrated in FIGS. 4-6, the cassette 36 can be relatively portable in size, measuring between about one and about three square meters in some embodiments, allowing for customized placement in existing walkways. For example, the sizing permits positioning multiple cassettes 36 in a variety of different configurations, such as any suitable abutting configuration, forming a walkway with minimal gaps in between cassettes 36. As such, one or more cassettes 36 may be of uniform or varying size and/or dimension and may be arranged so that all or a portion of at least one side of each cassette 36 can abut an adjacent cassette 36. Additionally, while the illustrated cassette 36 has a generally square perimeter, rectangular, circular, trapezoidal, irregular, and other shapes are contemplated. Further, adjacently arranged cassettes may have a corresponding shape to such that gaps between the cassettes may be minimized without regard for the geometrical shape of the cassette 36.

In some embodiments, variously sized cassettes 36 may be used based on the design of the walkway. In some instances, the cassette 36 may be configured as a corner member in which two adjacent sides of the cassette 36 are operably coupled with other cassettes. In such instances, the cassette 36 may include a panel 38 that includes a panel 38 and a pair of side members 58. The panel 38 and the side members 58 may be integrally formed with one another. The panel 38 may include any number of side members 58 based on the shape of the panel 38 and the number of the cassettes that are to be coupled with the corner cassette 36. The sides of the cassette 36 that are not coupled with adjacent cassettes may be coupled transition members 60. In some embodiments, the transition members 60 may be angled such that transition members 60 are non-parallel to the side members 58. For example, the transition member 60 can have a chamfered outer surface 62 and a generally vertical inner surface 64. In addition, the transition members 60 can include anchors 66 thereon for retaining the cassette 36 in position. The transition members 60 may be formed from a varied or common material as the panel 38. For example, in some embodiments, the transition members 60 may be formed from fiberglass material while the panel 38, and side members 58, may be formed from a metallic material.

In various embodiments, the end portions of the side members 58 and the transition members 60 may be separated by gaps 68. The gaps 68 may allow environmental debris, such as water, dirt, etc. to drain from a position under the panel 38 to a position outwardly of the panel 38. In some embodiments, water may be trapped under the cassette 36 that then freezes forming ice. When power is supplied to the cable, the ice may melt and then drain through the gaps 68.

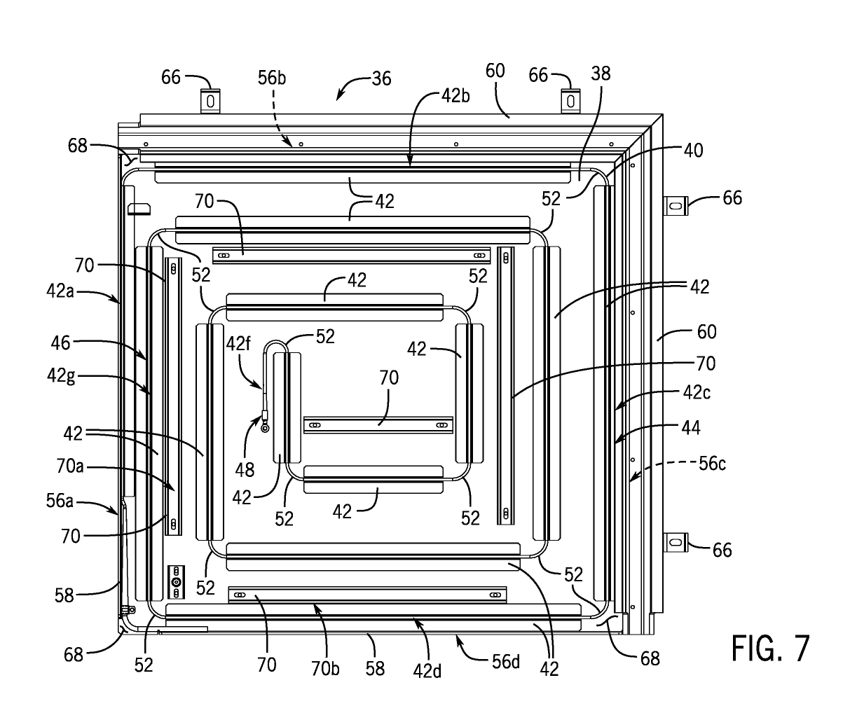

FIG. 7 illustrates an underside of a heat-traced anti-icing cassette 36 having a concentric cable routing arrangement, according to some embodiments. Generally, as shown in FIG. 7, the cassette 36 can include a panel 38 and one or more heating cables 40 (e.g., heat tracing cables) in thermal contact with an underside of the panel 38. A top side of the panel 38 can form a walking surface to be heated by the heating cable 40. Additionally, thermal insulation can be coupled to the underside of the panel 38, over the heating cable 40, to thermally insulate the underside of the cassette 36.

In some embodiments, the heating cable 40 may be any suitable heating cable for heating a metal or other corrosion-resistant walkway panel in extreme environments. Generally, any heat tracing cable with known applications in underfloor heating may be used, provided such heat tracing cable has weather-resistant properties. Similarly, heating cables 40 used in industrial heat tracing applications may be used, provided they have a suitable diameter, bend radius, and power requirements for use in the cassette 36. For example, in some embodiments, an unshielded heating cable 40 can be used (e.g., along with a component that grounds the cassette 36). In some embodiments, the heating cable 40 may be a shielded heating cable and may be a self-regulating cable (e.g. Raychem BTV, Raychem QTVR, or similar), a constant wattage cable (e.g. Raychem XPI or similar), a hazardous environment-rated cable, or another suitable type of cable. In some embodiments, the heating cable 40 can be a series resistance heating cable, such as a single-, double-, or triple-conductor series resistance heating cable.

The heating cable 40 can be in thermal contact with the underside of the panel 38 in any suitable manner. In some embodiments, such as the example shown in FIG. 7, the underside of the panel 38 can include one or more extruded channel segments 42, such as extruded aluminum channel segments 42, through which the heating cable 40 is routed. The channel segments 42 can be coupled to or integral with the panel 38 and can serve to transfer heat from the heating cable 40 to the panel 38. In some embodiments, as shown in FIG. 7, the extruded channel segments 42 can be straight-line channel segments 42 arranged along the underside of the panel 38 to accommodate a specific cable routing configuration, as further described below.

In some embodiments, the heating cable 40 may be fastened in place under the panel 38 with clips, and the clips can assist transferring heat from the heating cable 40 to the panel 38. In some embodiments, the heating cable 40 is fastened in place against the underside of the panel 38 using a suitable adhesive tape. In some embodiments, the tape can include properties that improve heat transfer from the heating cable 40 to the panel 38, such as a high thermal conductivity. In some embodiments, the tape may be an aluminum tape that helps improve heat transfer and minimize temperature gradients.

While some embodiments may implement clips or tape, the extruded channel segments 42 can provide improved heat transfer over these options. For example, the extruded channel segments 42 can provide better heat transfer compared to clips because extrusions provide more contact surface between the heating cable 40 and heat transfer surfaces compared to clips. More specifically, clips, being discrete objects, tend to concentrate force locally. Therefore, lengths of cable 40 not directly under clips tend to have low contact force, and poor heat transfer. In some examples, the extruded channel segments 42 may be superior to tape because they are much thicker than tape (for example, channel segments 42 are about 1.5 mm thick versus a tape thickness of about 0.1 mm). Thus, the channel segments 42 have a much wider thermal conduction path and lower thermal resistance compared to tape.

As shown in FIG. 7, the heating cable 40 may be routed in a concentric configuration along the underside of the panel 38. In other words, the channel segments 42 may be arranged along the underside of the panel 38 so that a heating cable 40 routed through the channel segments 42 is arranged in a concentric configuration. For example, in some embodiments, the heating cable 40 can be routed around an outer perimeter of panel 38 (e.g., forming the outer loop 44), then routed inside itself in a concentric manner (e.g., forming one or more inner loops 46) until terminating inside the perimeter (i.e., at the termination point 48).

In some embodiments, such as the example illustrated in FIG. 7, a first channel segment of the outer loop 44 is substantially parallel to a first section of the perimeter of the panel 38. A second channel segment is substantially parallel to a second section of the perimeter of the panel 38. Similarly, a third channel segment of the outer loop 44 is substantially parallel to a third section of the perimeter of the panel 38. A fourth channel segment of the outer loop 44 is substantially parallel to a fourth section of the perimeter of the panel 38. The heating cable 40 is positioned within each of the first, second, third, and fourth channel segments 42a, 42b, 42c, 42d and defines bend portions 50 between each respective channel segment 42a, 42b, 42c, 42d. Once positioned within the first, second, third, and fourth channel segments 42a, 42b, 42c, 42d, the cable 40 traverses substantially the entire outer perimeter of the panel 38. While the panel 38 of FIG. 7 has a generally square perimeter, some embodiments include a heating cable 40 that traverses an outer perimeter of a rectangular, circular, trapezoidal, irregular, or other shaped panel 38. Additionally, in some embodiments, the heating cable 40 may traverse less than the entire outer perimeter of the panel 38.

To accomplish concentric routing, the heating cable 40 can be bent at uniform or varying angles. For example, the heating cable 40 can be routed through a first channel segment 42, then bent and routed through a second, adjacent channel segment 42 at the bend portion 50. Generally, the heating cable 40 can be bent at any angle equal to, greater than, or less than 90 degrees, e.g., limited by the diameter and bend radius characteristics of the specific heating cable 40. In some examples, such as the outer loop 44 of FIG. 7, the first channel segment 42 is arranged about 90 degrees relative to the second channel segment 42. Thus, to accomplish cable 40 routing through the channel segments 42, the heating cable 40 can include substantially 90-degree angle bend portions 50. More specifically, the heating cable 40 can be routed straight through the channel segment 42, then bent about 90 degrees to be routed through the second channel segment 42. In some examples, the heating cable 40 is positioned within first and second channel segments 42 of the outer loop 44 that are offset from one another by less than 180 degrees. In some embodiments, the bend portions 50 may be external of the channel segments 42. However, in other embodiments, the bend portions 50 may be disposed within any of the channel segments 42, or otherwise coupled, with the panel 38.

In some embodiments, the routing configuration can include a loop 44, 46 having all substantially 90-degree bend portions 50. For example, all channel segments 42 in a loop 44, 46 may be relative to adjacent channel segments 42 at substantially 90-degree angles, where at least one channel segment 42 of the loop 44, 46 is shorter than an opposite channel segment 42 to permit the heating cable 40 to be routed inside itself to form a concentric inner loop 46. As shown in FIG. 7, the outer loop 44, for example, can include a first channel segment 42a along a first perimeter edge, a second channel segment 42b along a second perimeter edge, a third channel segment 42c along a third perimeter edge, and a fourth channel segment 42d along a fourth perimeter edge. The heating cable 40 can thus enter the first channel segment 42a, and be routed through the first channel segment 42a, the second channel segment 42b, the third channel segment 42c, and the fourth channel segment 42d to form the outer loop 44. The fourth channel segment 42d can be shorter than the opposite, second channel segment 42b to permit the heating cable 40 to be routed inside of the first channel segment 42a to begin forming one of the inner loops 46.

Additionally or alternatively, in some embodiments, one or more channel segments 42 in a loop 44, 46 can be angled less than or more than 90 degrees relative to adjacent channel segments 42, thus creating diagonal channel segments 42e, as shown in FIG. 2, to permit the heating cable 40 to be routed inside itself to form an inner loop 46. As such, as shown in FIG. 2, the configuration can include cable bend portions 50 inside the perimeter that are greater than 90 degrees.

In some embodiments, a final channel segment 42f of the cable 40 that defines the termination point 48 may extend in a direction that is opposite from an adjacent channel segment 42. In some examples, the final channel segment 42f may assist in biasing more heating cable 40 towards the sides of the panel 38 having the vertical members than the transition members 60. Herein, “biased” may be an orientation in which one or more of the concentric loops 44, 46 are offset from a center point of the panel 38.

Concentric routing, as described above, has a number of advantages compared to conventional serpentine routing. For example, when routed concentrically, the heating cable 40 can be located to optimize thermal uniformity and promote higher energy efficiency. More specifically, a concentrically arranged heating cable 40 does not need to traverse across the center of the cassette 36, unlike a serpentine arrangement. Therefore, excess heating of the center of the cassette 36, which often occurs with serpentine routing, can be avoided. Additionally, the concentric configuration can enable more efficient positioning of the heating cable 40 where heat loss is the greatest. More specifically, heat losses are greater at the outer perimeter of a cassette 36 (e.g., along its edges), so a higher density of heating cable 40 around the outer perimeter can be beneficial. The concentric arrangement provides higher flexibility for getting more heat to the outer perimeter. For example, the concentric arrangement of some embodiments more easily allows for the creation of loops 44, 46 that are biased to the outer perimeter of the cassette 36. Thus, by including one or more loops 44, 46 around the outside perimeter, a larger portion of heat transfer occurs along the perimeter to help counter these heat losses. In some examples, in order to provide an area that is heated sufficiently to remove ice from a walkway, the coldest area of the panel 38 may be heated to a minimum temperature. The amount of power needed to heat the coldest area of the panel 38 determines the amount of power usage by the cassette 36. In many cases, the coldest area is proximate to the perimeter of the panel 38. Thus, by biasing the cable 40 to the areas likely to have the lowest temperatures, less energy may be needed to heat the cassette 36, which may lead to lower operating costs.

Furthermore, the above-described concentric configuration promotes better thermal coupling of a heating cable 40 to the panel 38. As described above, an extruded aluminum channel segment 42 can be used to thermally couple the heating cable 40 to the panel 38. The channel segments 42 are generally installed on straight sections of heating cable 40. Therefore, thermal efficiency is improved if more of the heating cable 40 is straight and captured by the channel segments 42. As shown in FIG. 7, only minimal bend portions 50 are outside the extruded channel segments 42 and, thus, a majority of the heating cable 40 is thermally coupled to the panel 38 via the channel segments 42. In contrast, in the serpentine configuration shown in FIG. 1, the half-round looped ends 18 cannot be routed through straight channel segments 42 and, thus, less of the heating cable 14 is thermally coupled to the panel 12. In other words, when comparing the concentric configuration of FIG. 7 to the serpentine configuration of FIG. 1, more of the heating cable 40 in the concentric configuration can be routed through straight channel segments 42, thus promoting better thermal coupling of the heating cable 40 to the panel 38.

As illustrated in FIGS. 7-10, one or more supports 70 can be arranged between various channel segments 42 of the cable 40. In the example illustrated in FIG. 7, some of the supports 70 generally extend in a common direction with adjacently positioned channel segments 42. Moreover, the one or more supports 70 may be biased towards various portions of the perimeter. For example, similarly to the cable 40, the supports 70 may be generally biased towards the vertical members and away from the transition members 60.

The number of channel segments 42 between the perimeter of the panel 38 and the supports 70 may be varied. For example, in the embodiment shown in FIG. 7, a pair of channel segments 42a, 42g are arranged between a first side member 58a and a first support 70a while a second channel segment 42b is arranged between a second side member 58b and a second support 70b. Accordingly, the cable 40 and the supports 70 may be arranged in any fashion based on a desired heating profile, cable arrangement, weight support requirement, and so on.

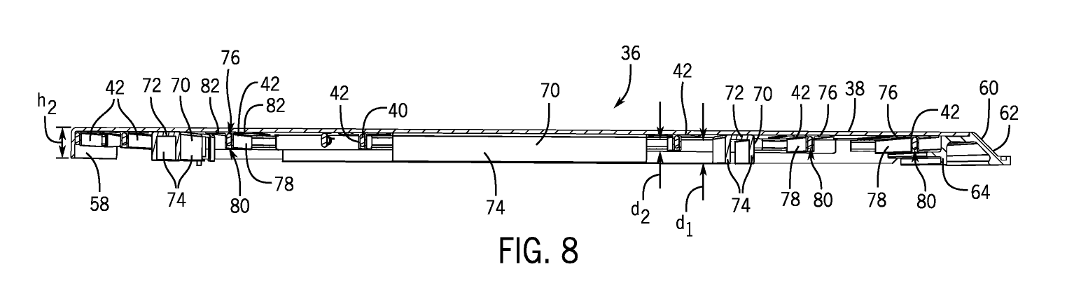

As illustrated in FIG. 8, in some embodiments, the panel 38 can be supported by the side members 58, the transition members 60, and the supports 70. In this manner, the supports 70 may extend a first distance d₁ from the panel 38 and the channel segments 42 may extend a second distance d₂ from the panel 38, wherein the first distance is greater than the second distance. Moreover, the height h₁ of the side members 58 may be substantially equal to the first distance d₁.

As illustrated in FIGS. 8-10, in some embodiments, the supports 70 may each define a substantially u-shaped profile in that each support 70 can include a central body 72 and two parallel side protrusions 74 extending from opposing sides of the central body 72. The channel segments 42 may include a base structure 76 and a pair of projections 78 extending from intermediate portions of the base structure 76 that together define a slot 80. One or more flanges 82 can be disposed laterally outward of the slot 80. The flanges 82 can increase an area upon which the channel segment 42 is thermally coupled with the panel 38 to increase thermal conductivity therewith. In some examples, some channel segments 42, such as the first channel segment 42a includes a single flange 82, while other channel segments 42, such as the second channel segment 42b, includes a pair of opposing flanges 82, while other channel segments 42 may not include any flanges 82.

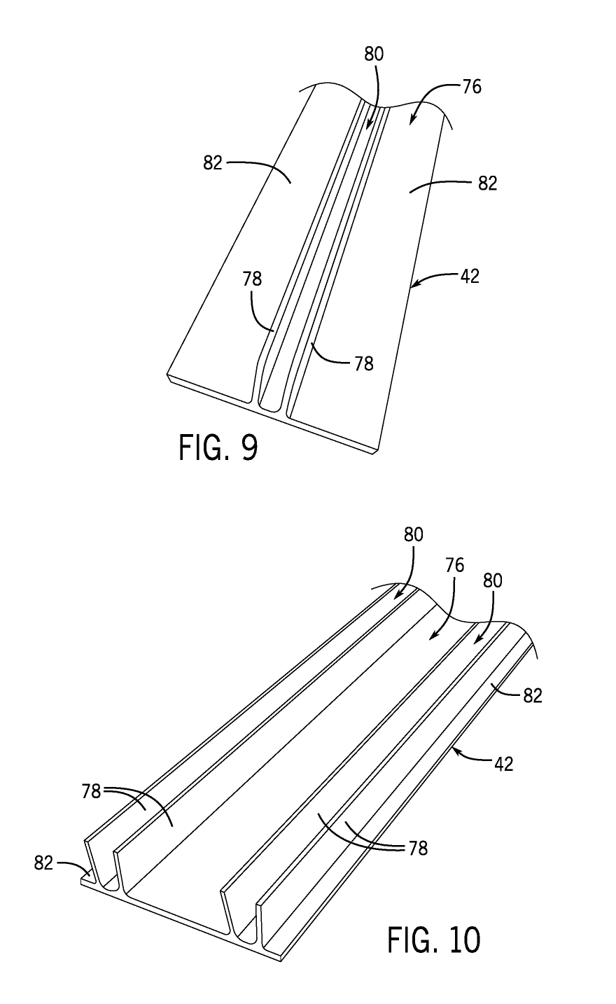

As illustrated in FIGS. 9 and 10, the channel segments 42 may include any number of projections 78. For example, when a single cable 40 is wound along the panel 38, the channel segments 42 may include a single pair of projections 78. In other examples, the cassette 36 may include first and second cables 40 may be aligned proximate on another and powered in series, or in parallel. In such examples, two pairs of projections 78 may be formed within each channel segment 42 so that each wire may be independently positioned within a respective pair of projections 78.

In some embodiments, a thermal compound may be disposed in between two projections 78 in addition to the cable 40. The thermal compound may further assist in directing heat from the cable 40 through the channel segments 42 and to the panel 38. The thermal compound may also seal the area between the projections 78 from the external environment. In one embodiment, the thermal compound can be a silicone type-gel that may include additives for increasing thermal conductivity. The thermal compound can prevent the ingress of an external contaminate into the area between the projections 78 and can also isolate the cable 40 away from the external atmosphere to prevent any electrical arcing from reaching the external atmosphere. The thermal compound can provide sufficient isolation of the electronic circuitry from the external atmosphere to satisfy regulatory requirements for hazardous environment, such as, for example, CSA, FM, PTB, DNV, IECEx, and InMetro Zones 1 and 2.

In light of the above, embodiments provide an anti-icing cassette including a concentric cable routing configuration that can provide improved heating of the cassette surface for, for example, preventing snow and ice formation on walkways.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, any of the features or functions of any of the embodiments disclosed herein may be incorporated into any of the other embodiments disclosed herein.

What is claimed is:

1. An anti-icing cassette, the cassette comprising:
a panel;
a plurality of channel segments arranged on an underside of the panel; and
a heating cable routed through the plurality of channel segments and arranged in a concentric manner, including an outer loop adjacent an outer perimeter of the panel and at least one concentric inner loop inside the outer loop.

2. The cassette of claim 1, wherein the heating cable terminates inside the outer loop.

3. The cassette of claim 1, wherein the plurality of channel segments includes a first channel segment, a second channel segment, a third channel segment, and a fourth channel segment arranged relative to each other to form the outer loop.

4. The cassette of claim 1, wherein the heating cable is bent at a substantially 90-degree angle to be routed from a first channel segment of the plurality of channel segments to an adjacent second channel segment of the plurality of channel segments.

5. The cassette of claim 1, wherein the plurality of channel segments include extruded metal slots defined by a base structure and a pair of projections extending from the base structure.

6. The cassette of claim 5, wherein the plurality of channel segments each include at least one flange positioned laterally outward of the pair of projections.

7. The cassette of claim 3, wherein the first channel segment is substantially parallel to a first section of a perimeter of the panel, the second channel segment is substantially parallel to a second section of the perimeter of the panel, the third channel segment is substantially parallel to a third section of the perimeter of the panel, and a fourth channel segment is substantially parallel to a third section of the perimeter of the panel.

8. The cassette of claim 1, further comprising:
one or more supports extending further from the panel than the plurality of channel segments arranged on an underside of the panel.

9. The cassette of claim 1, further comprising:
a transition member operably coupled with the panel, the transition member having a chamfered outer surface and a vertical inner surface.

10. An anti-icing cassette, the cassette comprising:
a panel;
a plurality of channel segments arranged on an underside of the panel, the plurality of channel segments including a first channel segment parallel to a first section of a perimeter of the panel and a second channel segment parallel to a second section of the perimeter; and
a first heating cable routed through the plurality of channel segments and arranged in a concentric manner, the first heating cable defining a bend portion between the first and second channel segment.

11. The anti-icing cassette of claim 10, wherein the first channel segment is arranged about 90 degrees relative to the second channel segment.

12. The anti-icing cassette of claim 10, wherein the panel includes a panel and a pair of side members extending downwardly from the panel, the side members disposed on adjacent sides of the panel and separated from one another.

13. The anti-icing cassette of claim 12, further comprising:
a pair of transition members operably coupled with two adjacent sides of the panel, the transition members including a chamfered outer surface.

14. The anti-icing cassette of claim 13, wherein the first heating cable is biased towards the vertical members and away from the transition members.

15. The anti-icing cassette of claim 10, further comprising:
a second heating cable, wherein the first and second cables are disposed in respective first and second slots within at least one of the plurality of channel segments.

16. A method of routing a heating cable on an underside of an anti-icing cassette, the method comprising:
routing the heating cable through a first plurality of channel segments coupled to the underside of the anti-icing cassette to form an outer loop adjacent to a perimeter the anti-icing cassette;
routing the heating cable through a second plurality of channel segments coupled to the underside of the anti-icing cassette to form an inner concentric loop inside the outer loop; and
terminating the heating cable at a location inside the outer loop.

17. The method of routing a heating cable of claim 16, wherein the routing the heating cable through a first plurality of channel segments and the routing the heating cable through a second plurality of channel segments biases the cable in an offset position from a center point of the cassette.

18. The method of routing a heating cable of claim 16, further comprising:
attaching a support to a panel of the anti-icing cassette between the outer loop and the inner loop.

19. The method of routing a heating cable of claim 16, wherein the routing the heating cable through a second plurality of channel segments step includes biasing the inner concentric loop towards a perimeter section of a panel of the anti-icing cassette.

20. The method of routing a heating cable of claim 16, wherein the routing the heating cable through a first plurality of channel segments step includes positioning the heating cable within first and second channel segments within the first plurality of channel segments, the first and second channel segments offset from one another by less than 180 degrees.
